(19) United States
(12) Patent Application Publication
(10) Pub. No.: US 2006/0109363 A1
(43) Pub. Date: May 25, 2006

(54) CCD having memory, image-forming device having the same, and image-forming method

(75) Inventor: Dae-gon Eun, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONIC CO., LTD., Suwon-si (KR)

(21) Appl. No.: 11/268,634

(22) Filed: Nov. 8, 2005

(30) Foreign Application Priority Data
Nov. 19, 2004 (KR) 10-2004-0095142

(51) Int. Cl. H04N 5/335; H04N 3/14

(52) U.S. Cl. 348/311; 348/294

(57) ABSTRACT

Disclosed is a ccd having memory. The memory store characteristics information such as CCD scale-up/down, start positions, and the like, so as to more easily and rapidly compensate for differences caused by CCD characteristics without extra compensation algorithm in a peripheral such as a scanner.

### CROSS-REFERENCE TO RELATED APPLICATIONS

This application claims benefit of Korean Patent Application No. 2004-95142 filed on Nov. 19, 2004, in the Korean Intellectual Property Office, the disclosure of which is incorporated herein by reference.

### BACKGROUND OF THE INVENTION

1. Field of the Invention

The present invention relates to a characteristics compensation device of an image-forming device and a method therefor. More particularly, the present invention relates to device and method for compensating for differences caused by the characteristics of a CCD.

2. Description of the Related Art

In general, a scanner refers to a device for converting data printed on documents into image data of the Bit Map format.

That is, as a device for converting documents, drawings, and the like, into digital data that can be stored in computers or sent through communication devices, the scanner can convert images into graphic files as well as convert books, documents, or the like, into characters that can be recognized by computers by using suitable software.

The basic operation principle of the scanner is to scan an object by light, measure an amount of reflected light, and convert the reflected light into an image. The operation steps of the scanner first scans an object by light, measures an amount of reflected light, produces a voltage of a certain level proportional to the light amount, and converts the voltage into a certain pixel pattern through a circuit built in the scanner.

Such scanners are classified into a line scanning type which scans line by line data written on documents, and a shuttle scanning type which scans data written on documents while a reader per pixel units moves back and forth in the direction perpendicular to the document movement directions. Further, the scanners are classified into color scanners and black/white scanners depending on what kind of an image sensor is used, that is, a color image sensor or a black/white image sensor, and, depending on how the scanners operate, the scanners are classified into hand-held scanners as a device moving a scanner over an object to be scanned, scanners of sheet-feed type that scan paper as the paper is fed in downwards when the paper is fed from the top as in inkjet printers, and scanners of flat-bed type that scan an object as an image sensor below the scanner glass moves when the object is loaded over the glass panel, which is most widely used.

As discussed above, the flat-bed scanner reads the content of documents by moving a scanning unit located below the scanner glass on which the document is loaded. Thus, the flat-bed scanners include a flat-bed scanning unit for photocopiers scanning documents or a flat-bed scanning unit of multi-function printers in addition to a dedicated flat-bed scanner used as a data-inputting device for computers.

In FIG. 1, a conventional flat-bed scanner includes a scanner glass 70, a scanning unit 60, a scanner shaft 50, a scanner slider 30, a rail 20, a base 10, and so on.

The rail 20 is mounted on one upper side of the base 10 in the direction for the scanning unit 60 to move, and the scanner shaft 50 is mounted on the upper side of the base 10 in parallel with the rail 20 and spaced from the rail 20 in order for the scanning unit 60 to be stably supported in moving. The both ends of the scanner shaft 50 are supported by a shaft supporter 40 protruded from the upper side of the base 10. The scanner slider 30 is mounted on the upper side of the rail 20 and slides along the rail 20. The scanning unit 60 is provided with a CCD image sensor reading documents, and one side of the scanning unit 60 is assembled with the scanner shaft 50, and the other side of the same is supported by the scanner slider 30 from the bottom thereof. The assembly of the scanning unit 60 and the scanner shaft 50 has a structure enabling the scanning unit 60 to slide along the scanner shaft 50, and, in general, the scanning unit 60 is provided with a brush, and a shaft having a round cross-section is mostly used as the scanner shaft 50. Therefore, the scanning unit 60 is structured to rotate up and down about the scanner shaft 50.

Document to be scanned is loaded on the top of the scanner glass 70, and the scanner glass 70 is installed on the upper side of the scanning unit 60 and has a size covering an area to be scanned by the scanning unit 60. Further, the scanner glass 70 is attached to a cover 80 assembled to the base 10, so as to maintain relations with the base 10. Further, even though not shown in the drawings, an image memory and a controller are included, in which the image memory stores data of the images scanned by the scanning unit 60 and the controller controls the operations of the scanner and communicates with a host computer connected to the scanner. Further, as scanning is performed over the documents loaded on the top of the scanner glass 70, the scanning unit 60 travels along the scanner slider 30 sliding over the scanner shaft 50 and the rail 20, reading and storing data of the documents in the image memory. Thereafter, the data is sent to the host computer so as to be stored in a file format or to be used as data to be sent when the facsimile function works.

In here, in order to scan information appearing on a document, the scanning unit 60 scans a document horizontally line by line from a start portion. Therefore, upon manufacturing peripherals such as scanners, makers get users to ignore or compensate for a difference occurring due to CCD characteristics when they use the peripherals. That is, extra steps are needed to compensate for the deviation between a physical start position and a scanning start position or for the scale difference.

Hereinafter, description will be made on a method for analyzing an image scanned by a scanner analyzing a difference caused by the CCD, and compensating accordingly for scanner characteristics every time the scanner is used, as one method for compensating for the difference.

First, a specific pattern is attached on a peripheral such as a scanner, and physical information (absolute values of the peripheral) such as pattern position and size is stored in advance. The peripheral uses the CCD of the scanning unit to scan the specific pattern, extracts the specific pattern from the scanned image, and reads the position information and size of the pattern. The peripheral compares the read information and the physical information of the pattern stored in advance and obtains a difference therebetween. If the CCD has no difference in scaling down or up, the read information should be no different as to a physical value, but there actually exists a difference between the two. The difference forms a deviation caused when the CCD scales up or down, so that, in consideration of the difference, an image is compensated for by being scaled down or up by the difference when actually scanned.

For example, if the size of the attached pattern is 100 and the size of the pattern extracted from an image is 90, the absolute size of the pattern means 100, but an image is read by the CCD in a size of 90 which is actually scaled down by 10. Therefore, the CCD has the scale-down characteristics compared to the normal value. If the CCD is used as it is without compensation, all scanned images are scaled down by 10% compared to original images, so that the CCD is compensated for. In order to scale up the size from 90 to 100, the size is 11% scaled up for compensation upon actual scanning so that an image of 100 is created.

Further, the peripheral such as a scanner finds a difference between the physical start position and the start position of a scanned image, and compensates by the difference for the start position.

As stated above, the conventional peripheral such as a scanner scans a specific pattern by use of the CCD, analyzes a scanned image, finds a physical pattern size and a difference between start positions, obtains a difference of CCD characteristics, and compensates for the difference, since the CCD characteristics information such as scale-up/down, start position, and the like is unknown. If image distortion occurs on a scanned image, the CCD can be erroneously compensated for. Further, the conventional peripheral has an inconvenient side since a processing becomes complicated due to an extra process for adding a compensation algorithm and it takes more time to perform the process.

### SUMMARY OF THE INVENTION

The present invention has been developed in order to solve the above drawbacks and other problems associated with the conventional arrangement. An aspect of the present invention is to provide a CCD having a memory for storing characteristics information such as CCD scale-up/down, start positions, and the like, so as to more easily and rapidly compensate for differences caused by CCD characteristics without extra compensation algorithm in a peripheral such as a scanner.

The foregoing and/or other aspects of the present invention are achieved by providing an image-forming device for scanning an image by using a CCD, comprising a CCD memory for storing at least one of the scale-up/down information and start position information of the CCD, a reader for reading the information stored in the CCD memory, and an image-processing unit for compensating for the start position information read out of the reader, scanning the image, and compensating for the scanned image with the read scale-up/down information.

The CCD memory is mounted to the CCD of the image-forming device.

The foregoing and/or other aspects of the present invention are achieved by providing an image-forming device for scanning an image by using a CCD storing unique numbers, comprising a unique number detector for detecting a unique number of the CCD, a CCD memory for storing at least one or more of the scale-up/down information and start position information of the CCD, a central processing unit for reading from the CCD memory the CCD characteristics information corresponding to the unique number by using the unique number detected by the unique number detector, and an image-processing unit for compensating for a to-be-scanned image based on the CCD characteristics information read by the central processing unit.

The image-processing unit compensates for the start position information read by the central processing unit, scans the image, and compensates for the scanned image with the read scale-up/down information.

The foregoing and/or other aspects of the present invention are achieved by providing an image-scanning method for an image-forming device for scanning an image by using a CCD memory for storing CCD characteristics information, comprising steps of reading the characteristics information of a CCD, compensating for the start position information out of the read characteristics information and scanning the image, compensating for the scanned image with the scale-up/down information out of the read characteristics information, compensating for the scanned image with the scale-up/down information out of the read characteristics information, and storing the position-compensated and scale-compensated image.

The CCD memory is mounted to the CCD of the image-forming device.

Another aspect of the present invention is achieved by providing an image-scanning method for an image-forming device for scanning an image by using unique number and characteristics information of a CCD, comprising steps of reading a unique number of the CCD, reading the characteristics information corresponding to the unique number, compensating for start position information out of the read characteristics information and scanning the image, and compensating for the scanned image with scale-up/down information out of the read characteristics information.

The CCD unique number is stored in the CCD of the image-forming device.

Further, one or more CCD unique numbers and CCD characteristics information corresponding to the unique numbers are preferably stored in a memory.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectioned view for schematically illustrating a conventional flat-bed scanner;

FIG. 2 is a block diagram for schematically illustrating a multi-function peripheral having a scanner function according to an embodiment of the present invention;

FIG. 3 is a flow chart for explaining a method for compensating for CCD characteristics information according to an embodiment of the present invention;

FIG. 4 is a view for exemplarily illustrating characteristics information stored in a CCD memory;

FIG. 5 is a block diagram for schematically illustrating a multi-function peripheral having a scanner function according to another embodiment of the present invention; and

FIG. 6 is a flow chart for explaining a method for compensating for CCD characteristics information according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

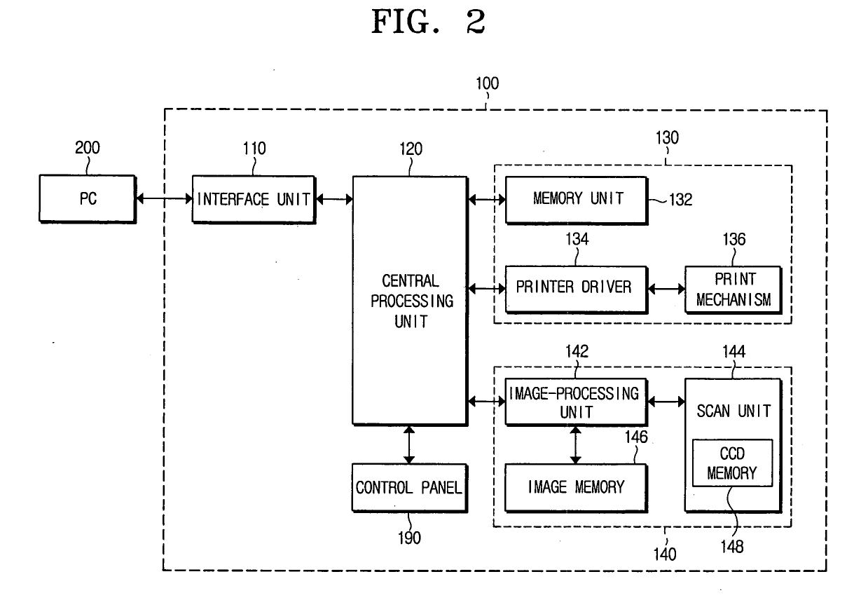

FIG. 2 is a block diagram for schematically showing a multi-function peripheral having a scanner function according to an embodiment of the present invention. As shown in FIG. 2, a multi-function peripheral 100 with a scanner function includes a printer part 130 provided with an interface unit 110, a central processing unit 120, a control panel 190, a memory unit 132, a printer driver 134, and a print mechanism 136, and a scanner part 140 provided with an image-processing unit 142, a scan unit 144, an image memory 146, and a CCD memory 148.

The host computer 200 edits, in thumb-nail data, files such as images to be printed out of a storage device as in prior art, and sends the data to the multi-function peripheral 100.

The control panel 190 enables a user to select and set a function supported by the multi-function peripheral 100, and has a display portion for displaying operation status information of the multi-function peripheral 100.

The interface unit 110 is connected between the host computer 200 and the central processing unit 120 to interface input and output signals therebetween, and the memory unit 132 has a ROM for storing various application programs and a control program for operating the central processing unit 120 and a RAM for temporarily storing data to be printed out of the host computer 200 through the interface unit 110 and various data occurring while the central processing unit 120 runs programs.

The central processing unit 120 is structured to control the operations of the printer driver 134 and the print mechanism 136 according to the control program stored in the memory unit 132 of the printer part 130.

The printer driver 134 controls the driving of the print mechanism 136 under the control of the central processing unit 120.

The print mechanism 136 is structured to pick up paper and form images thereon under the control of the printer driver 134.

The printer part 130 structured as above operates as below. That is, if the host computer 200 generates data to be printed (hereinafter, referred to as print data) and sends the print data through the interface unit 110, the central processing unit 120 reads the necessary control program and data from the memory unit 132, and generates a control signal for printing the print data. The generated control signal is applied to the printer driver 134. The printer driver 134 to which the control signal is applied controls the print mechanism 136 according to the applied control signal, and performs print jobs by forming characters on paper.

Hereinafter, description will be made on a structure of the scanner part 140.

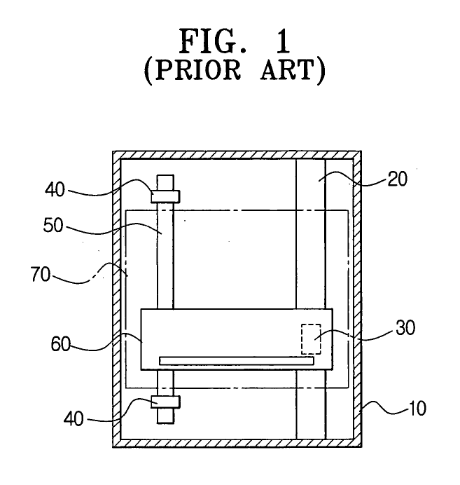

The scan unit 144 is built in the same structure as the conventional flat-bed scanner shown in FIG. 1, but a CCD sensor therein has the CCD memory 148 in which the CCD characteristics information is stored, wherein the CCD sensor reads in documents loaded on the scanning unit 60.

The CCD memory 148 is mounted to the CCD sensor, and stores characteristics information of a corresponding CCD sensor such as an unique number, scale-up/down percentage, start position, and so on. Such CCD memory 148 can be constructed with diverse memories including a CROM, a Radio Frequency Identification (RFID), or the like. In particular, in using the RFID, the scan unit 144 has to be built with an RFID reader. Since such components are well known in general, detailed description on the components will be omitted.

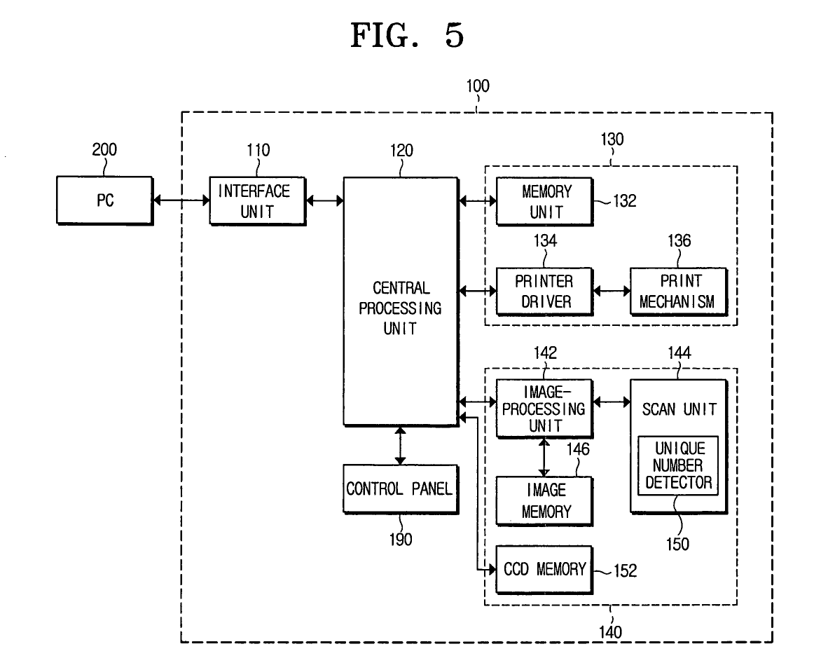

The image-processing unit 142 is constructed to read the characteristics information stored in the CCD memory 148, or compensate for scanned-image data sent from the scan unit 144 and store the compensated data in the image memory 146. In detail, the image-processing unit 142 reads the characteristics information such as position information and scale-up/down information from the CCD memory 148 mounted in the CCD, compensates for the scanned-image data based on the characteristics information, and stores the compensated data in the image memory 146. FIG. 4 exemplarily shows the characteristics information stored in the CCD memory 148. That is, the characteristics information is stored in a table format, and the table stores the characteristics information such as the unique numbers 410, start position information 420, and scale-up/down information 430 of corresponding CCDs. The start position information 420 denotes a physical start position, which can be denoted with a sign of “+” or “−”. The sign of “+” indicates that the physical start position of a corresponding CCD is deviated to the right compared to the start position for scanning an image. In such a case, when a document is scanned without compensation, undesired data is generated by a numeric value of the start position information 420 on the left side of a sheet of paper, and when scanned over a document having a scanning area of a regular size such as “A4” size, scanning is not performed over data corresponding to a numeric value of the position information on the right. Since such undesired data is dealt with as black data in the final print process, black lines are printed in the longitudinal direction on the left of a sheet of paper, causing the deterioration of print quality.

Thus, when the sign of “+” as above is denoted, the image-processing unit 142 compensates for the start position for scanning an image so that the scan unit 144 is driven to scan the image with the start position moved to the right by a corresponding numeric value.

Further, the sign of “−” means that the physical start position of a corresponding CCD is deviated to the left compared to the start position for scanning an image. In such a case, in the way contrary to the above, data on the left is not scanned upon scanning without compensation, and undesired data appears on the right. Therefore, the image-processing unit 142 compensates for the start position for scanning an image so that the scan unit 144 is driven to scan the image with the start position moved to the left by a corresponding numeric value. The position information is preferably compensated for before an image is scanned.

On the other hand, the scale-up/down information 430 denotes a scale-down percentage, and, the scale-up/down information denoted at “+10” indicates that the CCD has characteristics of scaling down by 10% compared to a normal size. Thus, all the scanned images are 10% scaled down compared to an original image when the CCD itself is used without compensation, so that compensation is made to obtain a 100% image by scaling up by as much as 11% upon actual scanning.

Further, if the scale-up/down information 430 is denoted at “−10”, images are 10% scaled up when scanned, so that compensation is made to obtain 100% images when scanned by scaling down by as much as 10%. Further, the compensation for the scale-up/down information is preferably made to compensate for firstly scanned images.

Through the compensation process as discussed above, the compensated images are stored in the image memory 146. Thereafter, the image data stored in the image memory 146 is sent to the host computer 200 through the interface unit 110 under the control of the central processing unit 120, and stored in a file format or used as transfer data when the facsimile function is used.

In the above, the image-processing unit 142 is structured to read out of the CCD memory 148 and compensate for the characteristics information, but it can be structured so that the central processing unit 120 reads the characteristics information out of the CCD memory 148 and the image-processing unit 142 compensates for the characteristics information.

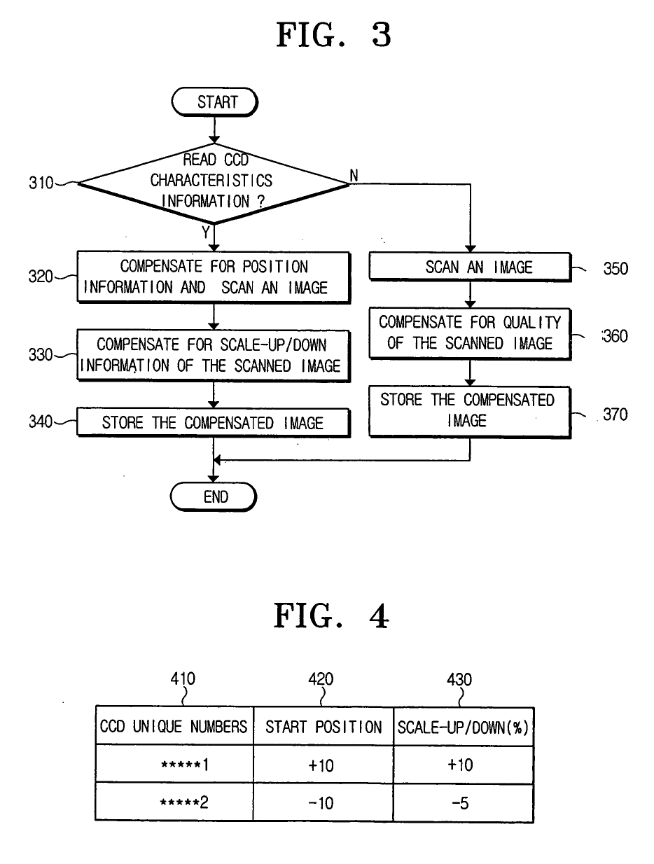

Hereinafter, description will be made on a characteristics compensation method with reference to FIG. 3 according to an embodiment of the present invention.

The image-processing unit 142 checks if the characteristics information of the CCD memory 148 is read out (operation 310), and, if not read, controls the multi-function peripheral to scan an image in general (operation 350), compensates for the quality of the scanned image (operation 360), and stores the compensated image into the image memory 146 (operation 370). If the CCD characteristics information is read in operation 310, the image-processing unit 142 compensates for the start position based on the read characteristics information and scans the image (operation 320). Next, the image-processing unit 142 scales up and down the scanned image for compensation (operation 330), and stores the start position and the scale-compensated image into the image memory 146.

Another embodiment of the present invention will be described with reference to FIG. 5.

An additional structure is applied to the embodiment of the present invention shown in FIG. 2. That is, a unique number detector 150 is installed so as to detect a unique number of a CCD when the CCD is mounted to the scan unit 144, and a CCD memory 152 is mounted that stores the characteristics information by each CCD unique number. If the CCD unique number is built with memories, the unique number detector 150 can be structured as a memory reader, and, if the CCD unique number is built with the RFID, the unique number detector 150 can be structured as an RFID reader, and, if the CCD unique number is built in bar code, the unique number detector 150 can be structured as a bar-code reader, so the detailed description on the above will be omitted.

In the embodiment of the present invention, if the unique number detector 150 detects each CCD unique number, the characteristics information by unique number stored in the CCD memory 152 is read, and a corresponding CCD is compensated for as above.

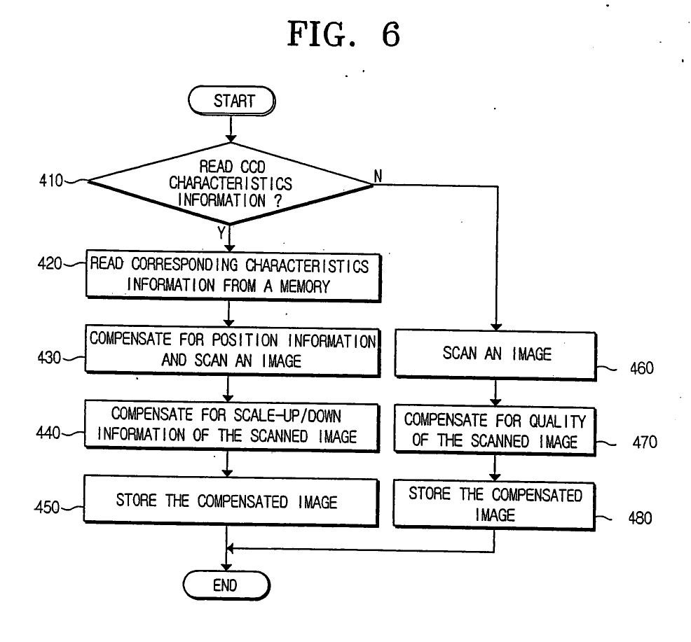

Hereinafter, description will be made on operations with reference to FIG. 6.

The image-processing unit 142 detects a unique number through the unique number detector 150 and notifies the central processing unit 120 of the unique number (operation 410), and then the central processing unit 120 reads the characteristics information corresponding to the unique number from the CCD memory 152 and sends the characteristics information to the image-processing unit 142 (operation 420). The image-processing unit 142 compensates for the sent position information and scans an image (operation 430), compensates for the scanned image based on the sent scale-up/down information (operation 440), and stores in the image memory 146 the image for which the position and scale are compensated (operation 450).

If the CCD unique number is not detected in operation 410, the image-processing unit 142 scans an image in general (operation 460), compensates for the scanned image (operation 470), and stores the compensated image in the image memory 146.

The image-processing unit 142 according to the embodiment of the present invention has been described to read and compensate for the CCD characteristics information stored in the CCD memory 148, but it can be structured that the central processing unit 120 directly reads from the CCD memory 148 and compensates for the characteristics information. That is, either the central processing unit 120 or the image-processing unit 142 can be used for a compensation unit for compensating for the characteristics information stored in the CCD memory 148.

The characteristics-compensating device and method for an image-forming apparatus stores in the CCD with a memory the characteristics information such as the scale-up/down percentage and start position, and a peripheral directly reads the characteristics information of a mounted CCD and compensates for the information according to the CCD characteristics, so that the characteristics-compensating device and method has an effect capable of simply and rapidly compensating for characteristics errors by eliminating unnecessary procedures for compensating for the scale-up/down percentage and the start position by scanning a specific pattern and obtaining a difference through comparison with a scanned image. Further, the characteristics-compensating device and method can prevent the error possibility due to image distortion when the characteristics are compensated for.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A charge-coupled device (CCD) for an image-forming device comprising a memory.

2. The CCD as claimed in claim 1, wherein the memory stores characteristics information for compensating for characteristics of the image-forming device.

3. The CCD as claimed in claim 2, wherein the characteristics information includes one or more of scale-up/down percentage, start position information, and unique number of the CCD.

4. An image-forming device comprising a CCD having a memory according to any of the claims 1 to 3.

5. An image-forming method for an image-forming device using a CCD having a memory, comprising:
reading characteristics information of the CCD; and
compensating for the characteristics of the CCD based on the read characteristics information.

6. The image-forming method as claimed in claim 5, wherein the reading the characteristics information of the CCD reads one or more of scale-up/down percentage, start position information, and unique number of the CCD.

7. The image-forming method as claimed in claim 5, wherein the compensating includes compensating for one or more of the scale-up/down percentage, start position information, and unique number of the CCD.

8. An image-scanning method for an image-forming device scanning an image by using a unique number and characteristics information of a CCD, comprising:
reading the unique number of the CCD;
reading the characteristics information corresponding to the unique number;
compensating for the start position information of the read characteristics information and scanning the image; and
compensating for the scanned image with the scale-up/down information of the read characteristics information.

9. The image-scanning method as claimed in claim 8, wherein the CCD unique number is stored in the CCD of the image-forming device.

10. The image-scanning method as claimed in claim 8, wherein one or more CCD unique numbers and CCD characteristics information corresponding to the unique numbers are stored in a memory.

11. A method, comprising:
determining whether characteristics information of a CCD memory is read out;
controlling a multi-function peripheral to scan an image if the characteristic information is not read out;
compensating for a predetermined quality of the scanned image if the characteristic information is not read out, or if the CCD characteristics information is read, compensating for a start position to scan an image based on the read CCD characteristics and compensating for scale up/down information of the scanned image; and
storing the compensated image in an image memory.

12. An apparatus, comprising:
an interface unit to interface input and output signals between a host computer and a central processing unit;
a memory unit to store application programs and a control program to operate the central processing unit, the memory unit temporarily storing data to be printed out of the host computer through the interface unit;
the central processing unit to control the operations of a printer driver and a print mechanism according to the control program stored in the memory unit;
the printer driver to control the driving of the print mechanism under the control of the central processing unit; and
the print mechanism structured to pick up paper and form images thereon under the control of the printer driver,
wherein an image-processing unit in communication with the central processing unit reads characteristics information stored in a CCD memory, or the image processing unit compensates for scanned-image data sent from a scan unit and stores compensated data in an image memory.
